(19) United States
(12) Patent Application Publication
(10) Pub. No.: US 2021/0306442 A1
(43) Pub. Date: Sep. 30, 2021

(54) ADDING OR REMOVING MEMBERS FROM CONFEDERATE RINGS

(71) Applicant: John Rankin, Williamsport, OH (US)

(72) Inventor: John Rankin, Williamsport, OH (US)

(21) Appl. No.: 17/141,746

(22) Filed: Jan. 5, 2021

Related U.S. Application Data
(60) Provisional application No. 62/957,357, filed on Jan. 6, 2020.

(51) Int. Cl. H04L 29/06; H04L 12/42

(52) U.S. Cl. CPC H04L 69/163; H04L 63/062; H04L 2012/421; H04L 12/42; H04L 63/061

(57) ABSTRACT

Systems and methods for adding a new member to, and/or removing an existing member from, a ring of confederate hosts are provided. To add the new member, an invitation is sent from a current member, and instructions are sent to a sequentially prior confederate host with instructions to set a source address for further communications to an address of the new member. As data payloads are received, they are forwarded from the new member to the current member. To remove the existing member, instructions are sent to a sequentially prior confederate host with instructions to set a source address for further communications to an address of a sequentially next confederate host. As data payloads are received, they are forwarded from the sequentially prior confederate host to the sequentially next confederate hosts, cutting out the existing member.

### CROSS-REFERENCE TO RELATED APPLICATIONS

This application claims the benefit of U.S. provisional patent application No. 62/957,357 filed Jan. 6, 2020, the disclosures of which are hereby incorporated by reference as if fully restated herein.

### TECHNICAL FIELD

Exemplary embodiments relate generally to systems and methods for adding or removing members from confederate rings.

### BACKGROUND AND SUMMARY OF THE INVENTION

Two of the most important communication protocols used on the Internet and other similar networks are the Transmission Control Protocol (TCP) and the Internet Protocol (IP). Together, the TCP and IP protocols form core protocols of the larger Internet protocol suite used on packet-switched networks. That protocol suite is commonly referred to as the TCP/IP protocol because of the widespread adoption and implementation of the TCP and IP protocols.

The TCP/IP protocol was developed for the United States Advanced Research Projects Agency (ARPA). The TCP/IP protocol is a set of rules that enable different types of network-enabled or networked devices to communicate with each other. Those network devices communicate by using the TCP/IP standard, or format, to transfer or share data. TCP/IP rules are established and maintained by the Internet Engineering Task Force (IETF). The IETF is an international community of network designers, operators, vendors, and researchers concerned with the Internet's architecture and operation. The IETF's mission is to produce technical and engineering documents that influence the way people design, use, and manage the Internet with the goal of improving its operations and efficiencies. These documents include protocol standards, best current practices, and information updates of various kinds, and are commonly referred to as Request for Comments (RFC).

TCP can be used to establish a bi-directional connection between two clients wherein activity begins with a request for information made by one client to another client. A “client” may be any program or application that initiates requests for, or sends information from, one remote location to another. As used herein, the term “client” may refer to such applications including, but not limited to, web browsers, web servers, file transfer protocol (FTP) programs, electronic mail programs, line printer (LPR) programs also known as print emulators, mobile phone apps, and telnet programs also known as terminal emulators, all of which operate conceptually in an application layer.

The TCP protocol is typically implemented as a “daemon” that is part of a TCP/IP stack of protocol layers. A daemon—also often referred to interchangeably as a server or service—is generally a software component of a device that runs a background process. The term “daemon” may refer to a component of a networked device that sends (source daemon) or receives (destination daemon), and processes communications between remote clients according to the TCP standard.

A host is a device or system that runs or executes TCP/IP daemons. The term “host” may refer to any device or system including, but not limited to, a server platform, a personal computer (PC), and any other type of computer or peripheral device that implements and runs TCP software. Generally, a host physically connects and links clients and daemons to TCP/IP networks, thereby enabling communication between clients.

TCP software accepts requests and data streams directly from clients and other daemons, sequentially numbering the bytes, or octets, in the stream during the time the connection is active. When required, the TCP software breaks the data stream into smaller pieces called segments (sometimes referred to as datagrams, fragments, or packets generally) for transmission to a requesting client. The protocol calls for the use of checksums, sequence numbers, timestamps, time-out counters and retransmission algorithms to ensure reliable data transmission.

The IP layer actually performs the communication function between two networked hosts. The IP software receives data segments from the TCP layer, ensures that the segment is sized properly to meet the requirements of the transmission path and physical adapters (such as Ethernets and CTCs). The IP software changes the segment size, if necessary, by breaking the segment down into smaller IP datagrams, and transmits the data to the physical network interface or layer of the host.

Using network communication protocols, such as but not limited to those described herein, it is possible to build a system and method for confidentially storing and forwarding data within a network of confederate hosts. The network may comprise one or more interlinked rings. Each ring may be comprised of a series of hosts who act as confederates, and forward data to other confederate hosts by way of blind hosts that are unaware of their involvement in the ring.

To assist in maintaining the integrity of the ring, no confederate may be aware of the existence of any other confederate, with the exception of the next confederate in the ring. Since communication between confederates may be operated using a blind host that is unaware of its involvement, a confederate receiving information may not be able to determine the actual origin of the data. What is needed is a system and method for adding and removing confederates from such rings.

Systems and methods for adding or removing confederates from such rings is disclosed. This extension and contraction of the rings may be accomplished without revealing the identity of members within the ring. By extending the ring to a new member, the confederation of members defining the ring may be expanded without compromising the security and integrity of the ring. Likewise, the process for contraction may allow the disassociation of a member without disturbing ring operation or compromising security and integrity. The size of the rings may each be expanded or contracted based on needs of the network or the individual rings, such as but not limited to, the amount of information in need of storage.

In exemplary embodiments, new members may be invited into a ring by an inviting, existing confederate member. The new member may be inserted into the ring sequentially before the inviting member. Communications may be made with the member sequentially behind the inviting member in the ring by sending a message forward around at least a portion of the ring using the cypher of the sequentially prior member and instructing the sequentially prior member to use a network address of the new member for further communications. Where the blind bounce back technique is used, this may be accomplished by instructing the sequentially prior member to set a source address of messages to the network address for the new member such that when messages are transmitted to a blind host, error protocols are triggered which cause the blind host to forward an error message comprising data payload to the new member, which the blind hosts believes to be the source of the message. The new member may use the same or similar techniques for forwarding the data payload to the inviting member to keep the ring pathway complete.

An existing member may exit the ring by communicating with the sequentially prior confederate in the ring and instructing the sequentially prior confederate to thereafter send messages to the sequentially next member in the ring, thereby bypassing the existing member while maintaining the ring pathway. As the existing member may not know the network address of the sequentially prior confederate in the ring but may know its encryption key, the instructions may be transmitted using the sequentially prior confederate's encryption key about the ring until reaching the sequentially prior confederate.

Despite the forwarding of information about the ring, anonymity in the ring may be preserved by using an encryption key of the relevant confederate such that only the relevant confederate can reasonably decrypt the information. This encryption key of the sequentially prior confederate in the ring is known by a sequentially next member to decrypt transmissions from the sequentially prior confederate.

Further features and advantages of the systems and methods disclosed herein, as well as the structure and operation of various aspects of the present disclosure, are described in detail below with reference to the accompanying figures.

### BRIEF DESCRIPTION OF THE DRAWINGS

In addition to the features mentioned above, other aspects of the present invention will be readily apparent from the following descriptions of the drawings and exemplary embodiments, wherein like reference numerals across the several views refer to identical or equivalent features, and wherein:

FIG. 1 is a simplified diagram of an exemplary ring;

FIG. 2 is a simplified diagram of an exemplary hook of a new confederate for the ring of FIG. 1;

FIG. 3 is a simplified diagram of an exemplary insertion of the new confederate into the ring of FIGS. 1 and 2;

FIG. 4 is a flow chart with exemplary logic for adding a new member to the ring; and

FIG. 5 is a flow chart with exemplary logic for removing a member from the ring.

### DETAILED DESCRIPTION OF EXEMPLARY EMBODIMENT(S)

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the present invention. In addition, descriptions of well-known functions and constructions are omitted for clarity and conciseness.

Embodiments of the invention are described herein with reference to illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

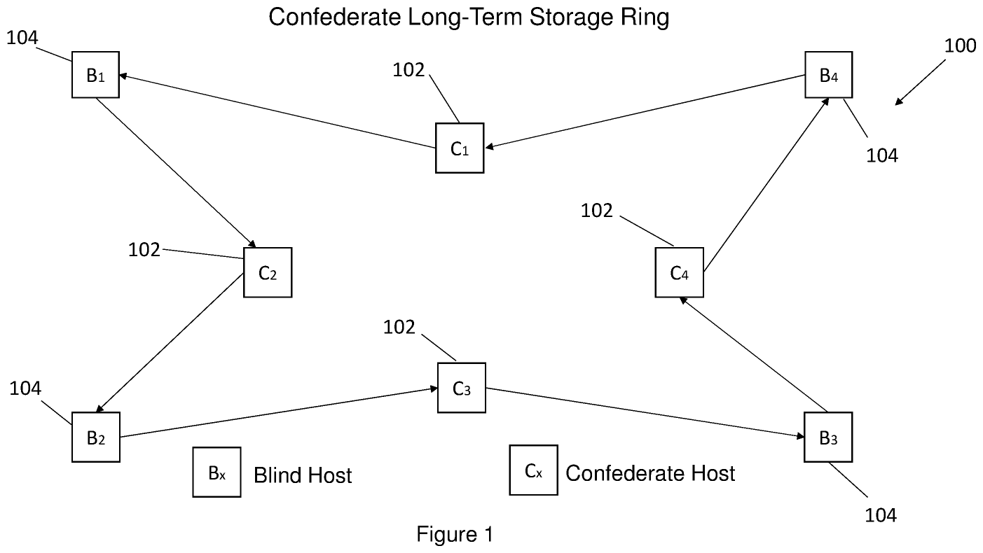

FIG. 1 illustrates an exemplary ring 100. The ring 100 may comprise a number of confederate hosts 102 and a number of blind hosts 104. The ring 100 may be formed on one or more networks, which may adhere to certain communication protocols, such as but not limited to, IP protocols. Such IP protocols may include, for example without limitation, Internet Control Message Protocols (ICMP). Each of the confederate hosts 102 and/or the blind hosts 104 may comprise computer systems of the same or different type, such as personal computers, tablets, smartphones, servers, or the like. The confederate hosts 102 may be labeled as C₁-C₄ in FIG. 1, though any number of confederate hosts 102 may be utilized. The blind hosts 104 may be labeled as B₁-B₄ in FIG. 1, though any number of blind hosts 104 may be utilized. The flow of data around the ring 100 is illustrated by arrows, though any flow path may be utilized.

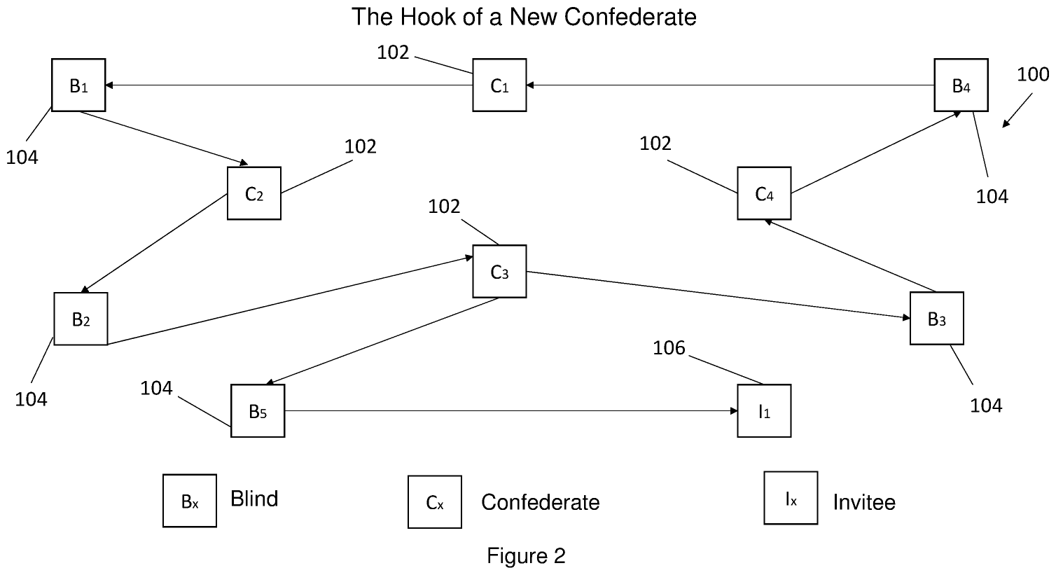

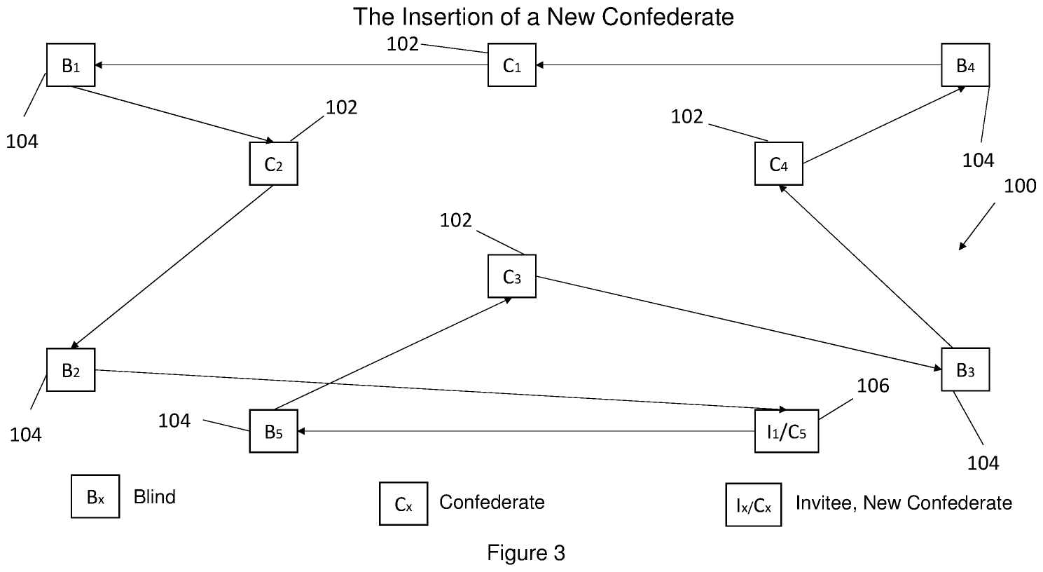

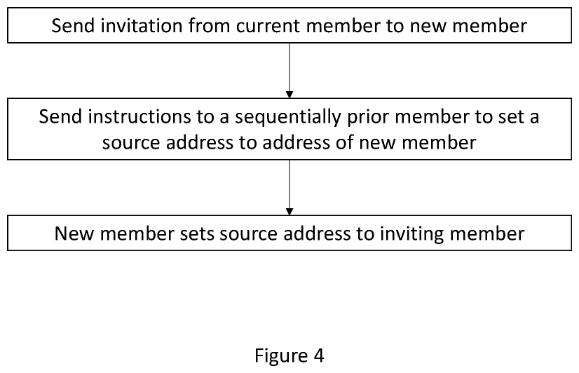

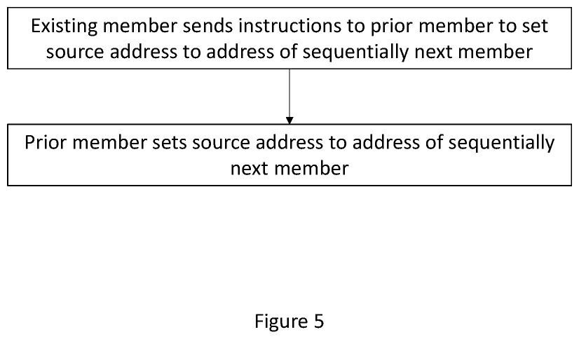

FIG. 2 illustrates hooking an invitee 106 for the ring 100. The invitee 106 may comprise a computing device such as a personal computer, tablet, smartphone, server, or the like. FIG. 3 illustrates insertion of the invitee 106 to the ring 100. FIG. 4 provides exemplary logic for adding the invitee 106 to the ring 100. FIG. 5 provides exemplary logic for removing an existing confederate host 102 from the ring 100. The invitee 106 may be labeled as I₁ in FIG. 2 and I₁/C₅ in FIG. 3, though any number of invitees 106 may be brought into the ring 100 at any location in such a fashion. Any number of existing confederate hosts 102 may be removed at any location in such a fashion. Expansion and contraction of the ring 100 may be accomplished by adding the invitee 106 to the ring 100 without revealing the identities of other hosts 102, 104 in the ring 100 to any participant not required to know. Contraction of the rings 100 may be achieved by removing confederates 102 without revealing information or identities of other hosts 102/104 in the ring 100 to any participants not required to know.

All extensions to the ring 100 may be initiated and controlled by a current confederate member 102 of the existing ring 100. As an invitation to join the network potentially raises security concerns, so the decision to expand the ring 100 by adding the invitee 106 may be controlled by one or more of the current confederate members 102 while revealing nothing more than the current confederate member's 102 own knowledge of the ring 100, which may be limited. This may be possible because no confederate member 102 of the confederate ring 100 may be aware of any other confederate member 102, with the exception that a given confederate member 102 may know the network address for a sequentially next confederate member 102 in the ring 100 so that the given confederate member 102 may supply a given blind host 104 with the address for the sequentially next confederate member 102 in the ring 100. Such transmission of information from each of the confederate hosts 102 to next confederate hosts 102 by way of the blind hosts 104 may be performed by way of a blind bounce back technique such as, but not limited, as shown and/or described in at least U.S. Pat. No. 10,728,220 issued Jul. 28, 2020 (hereinafter also the “'220 patent”) and/or US Pub. No. 2020/0379834 published Dec. 3, 2020 (hereinafter also the “'834 Pub.”), the disclosures of each of which are hereby incorporated by reference as if fully restated herein. Because transmissions arrive to a confederate member 102 from a blind host 104, no confederate member 102 may be aware of the origin of information received (i.e., the sequentially previous confederate member 102). Furthermore, by initiating membership from within the confederation 100, careful selection of new members 106 may be ensured.

Information Known to a Confederate

Each confederate host 102 may hold the following elements of information, provided without limitation:

1. The network address of the sequentially next confederate 102 in the ring 100. With this address, the confederate 102 may pass any information it receives onto the next confederate 102, such as by way of a blind host 104. This may permit long-term storage of information as well as general communication around the ring 100.

2. A confederate encryption key, which may be derived by the confederate host 102 to use for encrypting and decrypting traffic that is specifically intended for only the confederate host 102. This key may comprise a random block. Such encryption systems and methods may be those described in at least US Pub. No. 2019/0227772 published Jul. 25, 2019, 2019/0238315 published Aug. 1, 2019 (hereinafter also the “'315 Pub.”), and/or US Pub. No. 2019/0265951 published Aug. 29, 2019, for example without limitation, the disclosures of each of which are hereby incorporated by reference as if fully restated. The key may be passed forward to the sequentially next confederate 102 so that communication may be achieved between the confederate host 102 and the sequentially next confederate host 102 in the ring 100.

3. Since all confederate hosts 102 pass an encryption key forward, a given confederate host 102 may also have access to the encryption key from the sequentially previous confederate host 102. This element may be maintained so that a confederate host 102 can forward a message around the ring 100 that can only be read by the sequentially previous confederate host 102.

Ring Communication

Information may be passed around the ring 100 from one confederate 102 to another 102 by use of blind hosts 104. The blind hosts 104 may be used to mask the origin identity of the passed information. Each confederate 102 in the ring 100 may be aware of the sequentially next confederate 102 in the ring 100, and a ring 100 may be formed to cycle back to the first confederate host 102 to make a closed loop. See for example, without limitation, techniques shown and described in the '220 patent and/or the '834 Pub.

Since the information is continually cycling around the loop or ring 100, such communication may be seen by all confederate hosts 102 in the ring 100, with the exception of the blind hosts 104 who are unaware of the transmission. However, since confederate hosts 102 are unaware of the identity of any other confederate hosts 102, there may be two mechanisms to communicate specifically:

1. A confederate host 102 may communicate with the confederate host 102 that is sequentially next in the ring 100. This is because the network address of this host 102 is available so that the information may be forwarded around the ring 100. Communication may be secured through various encryption systems and methods, such as but not limited to those described in the '315 Pub.

2. A confederate host 102 may communicate with the sequentially prior confederate host 102 in the ring 100. This may be accomplished by coding a message with the encryption key or random block that was provided to the confederate host 102 from the sequentially previous confederate host 102. Once a message has been encoded, the confederate host 102 may transfer this message forward in the ring 100 to the sequentially next confederate 102. This forwarding may continue until each member 102 of the ring 100 has received the message and the message arrives back at the sequentially prior confederate 102 before returning to the confederate host 102 who originated the message. The sequentially previous host 102 may be capable of decoding the message, as it is the originator of the encryption key or random block.

The Hook

When a confederate host 102 selects an invitee host 106 to potentially add to the ring 100, the confederate hosts 102 may send an invitation to the invitee host 106 with an encoded invitation. The invitee 106 may not solicit membership in the ring 100, as this may be a way to invade and infect the security of the network 100. Therefore, rather than compromise the integrity of the network 100, an already secured and trusted confederate member 102 may instead select a trusted invitee host 106 through invitation. By using a blind host 104 as an intermediary, the confederate ring 100 may remain intact until the encoded invitation is accepted and verified.

The Insertion

The invitee member 106 may be joined to the ring 100 without revealing any more information than is necessary. Since the invitee 106 may be contacted by a specific confederate member 102 of the ring 100, it is only this inviting confederate member 102 that may continue to be the invitee member's 106 contact. In this way, the integrity of the other members 102 of the ring 100 may be maintained. To maintain this integrity, the confederate 102 offering the membership to the invitee 106 may be the only way by which a new invitee 106 may join and communicate with other members 102 of the ring 100.

Insertion of the invitee 106 into the ring 100 may be accomplished by transmitting a message from the inviting confederate member 102 to its current sequentially previous confederate 102 by forwarding instruction encrypted with the previous member's 102 encryption key about the ring 100. These instructions may tell the current sequentially previous member 102 of the ring 100 to change the address of the sequentially next confederate 102 from that of the offering confederate member 102 to that of the new invitee 106. Since the invitee 106 is already aware of the existence of the offering member 102, the invitee 106 becomes the offering member's 102 new sequentially previous confederate 102, and the offering confederate 102 is now sequentially next in the ring 100 from the invitee 106. In this way, the existence and addresses of all other members 102 of the ring 100 are preserved as private and confidential.

The Exit

In order for a confederate member 102 to withdraw from the ring 100, the confederate member 102 may transmit instructions around the ring 100 to its sequentially previous confederate 102 and replace the sequentially previous confederate's 102 sequentially next in ring address with the current confederate's 102 sequentially next in the ring 100 address. This may allow the exiting confederate member 102 to relinquish their role in the ring 100 by turning over their forwarding responsibilities to their sequentially previous confederate 102.

The instructions transmitted to the sequentially previous and next members 102 may include information that updates the three aforementioned elements held by confederate members 102 within the confederate ring 100. By following these techniques, confederate rings 100 may expand and contract without concern for loss of their integrity. Furthermore, the operation and function of the ring 100 may not be disturbed during expansion and contraction.

Any embodiment of the present invention may include any of the features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Certain operations described herein may be performed by one or more electronic devices. Each electronic device may comprise one or more processors, electronic storage devices, executable software instructions, and the like configured to perform the operations described herein. The electronic devices may be general purpose computers or specialized computing device. The electronic devices may be personal computers, smartphone, tablets, databases, servers, or the like. The electronic connections and transmissions described herein may be accomplished by wired or wireless means.

What is claimed is:

1. A method for adding a new member to a ring of confederate hosts, said method comprising the steps of:
sending an invitation from an existing one of said confederate hosts of said ring to said new member;
sending instructions forward within the ring to a sequentially prior one of said confederate hosts relative to said existing one of said confederate hosts, said instructions comprising instructions for said sequentially prior one of said confederate hosts to set a source address for further communications for said ring to an address of said new member; and
forwarding received data payloads from said new member to said existing one of said confederate hosts of said ring.

2. The method of claim 1 wherein:
messages are transmitted about said ring by way of blind hosts.

3. The method of claim 2 wherein:
said messages are transmitted about said ring using a blind bounce back technique.

4. The method of claim 3 wherein:
said confederate hosts and said blind hosts are connected to one another by way of an IP network.

5. The method of claim 1 wherein:
each of said confederate hosts utilizes a respective encryption key.

6. The method of claim 5 further comprising the steps of:
transmitting, from a respective one of said confederate hosts to a sequentially next one of said confederate hosts, the encryption key of said respective one of said confederate hosts.

7. The method of claim 6 further comprising the steps of:
sending, from said existing one of said confederate hosts of said ring to said new member, the encryption key of said sequentially prior one of said confederate hosts.

8. The method of claim 7 wherein:
each of said encryption keys comprise a respective random block.

9. A method for removing an existing member from a ring of confederate hosts, said method comprising the steps of:
sending instructions from said existing member of said confederate hosts forward within said ring to a sequentially prior one of said confederate hosts relative to said existing member, said instructions comprising instructions for said sequentially prior one of said confederate hosts to set a source address for further communications for said ring to an address of a sequentially next one of said confederate hosts relative to said existing member; and
forwarding received data payloads from said sequentially prior one of said confederate hosts to said sequentially next one of said confederate hosts.

10. The method of claim 9 wherein:
messages are transmitted about said ring by way of blind hosts.

11. The method of claim 10 wherein:
said messages are transmitted about said ring using a blind bounce back technique.

12. The method of claim 11 wherein:
said confederate hosts and said blind hosts are connected to one another by way of an IP network.

13. The method of claim 9 wherein:
each of said confederate hosts utilizes a respective encryption key.

14. The method of claim 13 further comprising the steps of:
transmitting, from a respective one of said confederate hosts to a sequentially next one of said confederate hosts, the encryption key of said respective one of said confederate hosts.

15. The method of claim 14 further comprising the steps of:
sending, from said existing member to said sequentially prior one of said confederate hosts, the encryption key of said existing member.

16. The method of claim 15 wherein:
each of said encryption keys comprise a respective random block.

17. A method for adding a new member to, and removing an existing member from, a ring of confederate hosts, said method comprising the steps of:
sending an invitation from a current one of said confederate hosts of said ring to said new member;
sending instructions forward about the ring to a sequentially prior one of said confederate hosts relative to said current one of said confederate hosts, said instructions comprising instructions for said sequentially prior one of said confederate hosts to set a source address for further communications for said ring to an address of said new member;
forwarding received data payloads from said new member to said current one of said confederate hosts of said ring;
sending instructions from said existing member of said confederate hosts forward about said ring to a sequentially prior one of said confederate hosts relative to said existing member, said instructions comprising instructions for said sequentially prior one of said confederate hosts to set a source address for further communications for said ring to an address of a sequentially next one of said confederate hosts relative to said existing member; and
forwarding received data payloads from said sequentially prior one of said confederate hosts to said sequentially next one of said confederate hosts.

18. The method of claim 17 wherein:
messages are transmitted about said ring by way of blind hosts;
said messages are transmitted about said ring using a blind bounce back technique;
said confederate hosts and said blind hosts are connected to one another by way of an IP network; and
each of said confederate hosts utilizes a respective encryption key.

19. The method of claim 17 wherein:
each of said confederate hosts comprises a server.

20. The method of claim 17 further comprising the steps of:
transmitting, from each of said confederate hosts to a sequentially next one of said confederate hosts relative to a respective one of said confederate hosts, a respective encryption key of said respective one of said confederate hosts, wherein each of said encryption keys comprise a respective random block;
sending, from said current one of said confederate hosts of said ring to said new member, the encryption key of said sequentially prior one of said confederate hosts relative to said current one of said confederate hosts; and
sending, from said existing member to said sequentially prior one of said confederate hosts relative to said existing member, the encryption key of said existing member.
